(19) United States
(12) Patent Application Publication
(10) Pub. No.: US 2019/0281777 A1
(43) Pub. Date: Sep. 19, 2019

(54) CLIMATICALLY SEALED CLIMATE-CONTROLLED CELL FOR INDOOR CULTIVATION OF PLANTS

(71) Applicant: Farmers Cut GmbH, Hamburg (DE)

(72) Inventor: Mark KORZILIUS, Hamburg (DE)

(21) Appl. No.: 16/346,617

(22) PCT Filed: Nov. 3, 2017
(86) PCT No.: PCT/EP2017/078178

§ 371 Date: May 1, 2019

(30) Foreign Application Priority Data
Nov. 4, 2016 (DE) 10 2016 121 126.5

(51) Int. Cl. A01G 31/06; A01G 7/02; A01G 7/04

(52) U.S. Cl. CPC A01G 31/06; A01G 7/045; A01G 7/02

(57) ABSTRACT

In order to further improve a climatically sealed climate cell for cultivating plants in indoor spaces so that contaminants of any type contained in the water supply or in the nutrient solution do not lead to disease in the roots or in the plant, it is proposed that a substrate that is disposed in the accommodation area (12) of a container (10) by means of at least one fixing means is temporarily or permanently fastened to the frame (14).

The invention relates to a climatically sealed climate cell for cultivating plants in indoor spaces, wherein a plurality of containers is disposed one above the other in at least two tiers inside the climate chamber. Each container comprises an accommodation area with a substrate disposed in the manner of a sheet to accommodate the plants and/or to accommodate seeds, wherein the container comprises a frame which surrounds the perimeter of the accommodation area.

The cultivation of plants in greenhouses is known. In this regard, it was usual to use artificial light in the evenings and during the winter months in order to force the growth of the plants. Because LED-based means of illumination have advanced, nowadays, electricity-consuming means of illumination can be replaced and they can be positioned in the immediate vicinity of the plants because of their comparatively low heat emissions. This in turn means that a plurality of tiers can be disposed one above the other, whereupon planting areas are disposed vertically one above the other and permanent artificial lighting can be installed between them.

Hydroponic and aeroponic systems are known for the irrigation of plants. In hydroponic systems, substrates formed from rock wool, glass wool or coconut coir may be used, for example. Seeds are sown into the substrates and either supplied with water and nutrients in accordance with the ebb/flood method or in accordance with the NFT. The disadvantage in this regard is that germs, for example, can be transferred to the rhizosphere of the plants via the water supply or nutrient supply. Furthermore, algae grow because light and nutrients come together in the rhizosphere.

In what is known as the aeroponic method, the roots of a plant are freely suspended and are sprayed at regular intervals with a fine mist of nutrients and water. The disadvantage again with aeroponic methods is that germs can be transferred via the water supply and nutrient supply. Systems for aeroponic processes require a great deal of space, particularly in the vertical direction. Furthermore, systems of that type are often vulnerable from a technical viewpoint. As an example, the spray nozzles have to be cleaned or changed frequently.

### PRIOR ART

CN 205 161 271 U discloses a container for cultivating plants.

EP 27 19 272 A1 describes a method for cultivating vegetables, fungi or herbs in a box.

DE 19 28 939 describes a climate chamber for cultivating plants in indoor spaces.

DE 1 77 86 24 describes a device for conditioning air for a climate chamber.

### DESCRIPTION OF THE INVENTION: OBJECTIVE, SOLUTION, ADVANTAGES

The objective of the present invention is to further improve a climatically sealed climate cell for cultivating plants in indoor spaces in a manner such that contaminants which might be contained in the water supply or in the nutrient solution, for example germs, do not cause diseases in the roots or the plant. In addition, algae formation in the rhizosphere of the plants should be prevented or at least reduced. A further objective of the present invention is to make the disposition of individual tiers inside the climatically sealed climate cell as economical on space as possible, so that as many tiers as possible can be disposed one above the other in a small space and, compared to known solutions from the prior art, as little water as possible is required for irrigation of the plants.

In accordance with the invention, in this regard, a climatically sealed climate chamber for cultivating plants in indoor spaces is proposed, wherein a plurality of containers is disposed one above the other in at least two tiers inside the climate chamber. In this regard, each container comprises an accommodation area with a substrate disposed in the manner of a sheet to accommodate the plants and/or to accommodate seeds. The container comprises a frame which surrounds the perimeter of the accommodation area. In accordance with the invention, the frame comprises at least one fixing means for temporarily or permanently fastening the substrate to the frame. Thus, the container consists of at least the peripheral frame. Optionally, the container may have a base.

The climatically sealed climate cell may thus be considered to be a plant cultivation system for cultivating plants in indoor spaces. Because there are at least two tiers, the system should be considered to constitute an Indoor Vertical Farming System.

In this regard, the at least one container is preferably configured as a carrying container. The seed or the plant may be placed on the substrate in a precise and managed manner, either manually or using a machine.

Inside the climatically sealed climate cell, an optimal climate is established for the plants to be cultivated. In order to be able to establish an optimal climate inside the climate cell, the climate cell preferably comprises regulating means to regulate a temperature and/or a relative humidity and/or a carbon dioxide content and/or an oxygen content and/or an air speed inside the climate cell.

In accordance with the invention, at least two containers are provided, i.e. one container on each tier. Preferably, however, on each level or tier, a plurality of adjacent and/or successively disposed containers may be provided. The individual tiers are disposed in the vertical direction, i.e. one above the other. A single tier extends in the horizontal direction or along a horizontal plane. Illumination means, in particular LED-based illumination means, may be disposed above each tier in order to illuminate the plants.

The container may have any suitable geometry. As an example, the container may be round, polygonal or oval in configuration. Particularly preferably, however, the container is rectangular in configuration. Furthermore, the container may consist of any suitable material or comprise any suitable material. Particularly preferably, however, the container consists of plastic or comprises plastic. The maximum length and/or width of the container is preferably three metres.

The substrate acts as a support and/or for fixing the seed or plants in the accommodation area. In this regard, the substrate is essentially sheet-like in construction and disposed in the accommodation area in a sheet-like manner. The accommodation area is thus formed by the container and surrounded or bordered by the container.

The at least one fixing means may be solidly, i.e. permanently, connected to the frame or may be disposed on the frame. In this manner, the at least one fixing means may be an integrated component of the container. Alternatively, however, the at least one fixing means may also be releasably connected to the frame or the container. The at least one fixing means may be configured as a retaining device and/or clamping device in order to retain or clasp the substrate on the frame.

Because the substrate is fixed to the frame of the container by means of at least one fixing means, the transfer of germs onto the seeds or into the rhizosphere of the plants can be avoided to the greatest extent possible.

More particularly advantageously, the plants can remain in the container throughout their growth phase from germination of the seed to harvest. As a function of the type of plant and the growth phase, the container can be transported from one station to the next station inside the climate cell or even to another climate cell. As an example, until germination of the seed, a climate which differs from that after germination may be required. Alternatively, the container could remain in the same climate cell throughout all of the growth phases and only the climate and/or the light intensity could be adjusted afresh as a function of the respective growth phase. The fully grown plants may also be transported to the consumer with the container, so that it is only necessary to harvest the plants immediately before processing and/or consumption. This is made possible because in particular, the substrate is fixed and fastened to the frame.

Preferably, the substrate is configured as a film and/or mat and/or membrane, in particular as a hydromembrane. Particularly preferably, the membrane is configured as a permeable membrane.

More preferably, the membrane is designed to be permeable to particles, in particular particles of water and/or nutrient particles, up to a maximum particle size of 5 nm, particularly preferably up to a maximum particle size of 2.5 nm, and more particularly preferably up to a maximum particle size of 1.5 nm. Larger particles, in particular germs and viruses, cannot therefore pass through the membrane.

Particularly preferably again, a first side of the substrate lies on a liquid nutrient solution, wherein the plant and/or the seed lies on a second side of the substrate facing away from the liquid nutrient solution. Particularly preferably, no liquid nutrient solution and no water are disposed on the second side.

As an example, the lower side of the substrate may be flushed with a nutrient solution at a uniform distance or interval. In this regard, the nutrient solution is preferably always supplied from below the substrate, because otherwise, the risk of the ingress of germs via the nutrient solution into the rhizosphere of the plants would be increased. In this manner, the build-up of algae in the rhizosphere can also be counteracted or prevented in its entirety. The substrate thus preferably floats on the nutrient solution. In this manner, algae can only form underneath the substrate and thus on the side facing away from the rhizosphere.

The roots of the respective plants only form on the upper side of the substrate. The roots do not grow through the substrate, or even into the substrate, and thus do not protrude into the nutrient-rich water disposed below the substrate. The roots simply form fine little arms which are distributed around the seed on the substrate. Because of the permeable nature of the substrate, water and nutrients can reach the roots. The upper side of the substrate thus preferably remains dry. In this manner, all substances which are not water or nutrients can remain below the substrate. At the same time, all of the roots lie on the upper side of the substrate in the open atmosphere. The proportion of oxygen in the air is substantially higher than the proportion of oxygen dissolved in the water. In this manner, the roots can be supplied with sufficient oxygen from the air.

Preferably, the substrate is fixed to the frame elevated compared with the accommodation area, by means of the fixing means. As an example, in the region of the frame, the substrate may be lifted up, elevated or folded upwards in order to prevent overflow or transfer of the water or the nutrient solution onto the upper side of the substrate. Particularly preferably, the substrate is fixed to the frame elevated, compared with the accommodation area, by at least 0.5 cm, more particularly preferably by at least 1.0 cm, by means of the fixing means.

Preferably, the at least one fixing means partially or completely surrounds the container. Preferably again, the at least one fixing means is disposed along the frame. In this regard, the fixing means may be disposed on and along the frame, for example peripherally. The fixing means may be mechanical in configuration. As an example, the fixing means may be integrated into the frame and/or clipped onto and/or pushed onto and/or screwed on and/or bonded.

Particularly preferably, the frame is formed in multiple parts, in particular in two parts, wherein the fixing means is formed by at least one frame part. As an example, two frame parts may be provided which are plugged on top of one another and the substrate is clamped between the two frame parts. In this regard, particularly preferably, one of the two frame parts may have a greater height than the second frame part. In this manner, the substrate can be clamped closer to the upper edge on the frame or be clamped between the two frame parts.

Preferably, the first frame part has a groove. The second frame part preferably has a tongue. In this manner, both frame parts can be connected by means of a tongue-and-groove connection, whereupon the substrate is clamped and fixed between the two frame parts. The two frame parts can be plugged inside one another or one on top of the other via the tongue-and-groove connection. The substrate can be clamp or tensioned between the groove and tongue.

More preferably, the container comprises a base with apertures or a lattice-like base, wherein the substrate lies on the base. In this manner, the base forms the accommodation area.

The container may be disposed in a tray-shaped accommodation unit. Particularly preferably, a plurality of containers may be disposed in one tray-shaped accommodation unit. As an example, up to twelve containers may be disposed in one tray-shaped accommodation unit. The tray-shaped accommodation unit may have any suitable shape or geometry. Particularly preferably, the basin-shaped accommodation unit is square or rectangular in configuration. As an example, the tray-shaped accommodation unit may be configured as a transport unit for transporting the containers disposed therein or as a fixed track or channel. The containers may be displaced or moved inside the tracks.

The water or the liquid nutrient solution may be disposed in the tray-shaped accommodation unit. To this end, the tray-shaped accommodation unit may comprise an inlet and/or an outlet opening for the aqueous nutrient solution. The container or the containers may stand or lie in the tray-shaped accommodation unit, or they may float inside the tray-shaped accommodation unit on the liquid nutrient solution.

Preferably, the at least two tiers are formed by essentially annular or circular or part-circular or polygonal platforms disposed one above the other, wherein a plurality of containers are respectively disposed on one platform. In addition, a plurality of tray-shaped accommodation units may be provided on each platform, wherein again, a plurality of containers is disposed in each tray-shaped accommodation unit.

Particularly preferably, the platforms may be part-circular in configuration, i.e. configured in the form of a circular section or circular sector. In this manner, a gangway or path is provided into the middle central section. In addition, each platform may be essentially annular in configuration with an inner radius and an outer radius. In this manner, a central recess or central opening is formed in which personnel or automatic sorting and/or sowing systems may be disposed. In this regard, the outer radius is larger than the inner radius of the platform. Preferably, the individual platforms are rigid, meaning that they are not mounted in a turnable or rotatable manner.

Each platform is preferably provided with a plurality of mutually separated and radially orientated tracks in which the containers are disposed and which can be displaced from an inner part of the platform in the direction of an outer part of the platform. Rows of plants are formed by the individual tracks. In this manner, the individual rows of plants are disposed in the shape of a star on the platforms. In the tracks, an aqueous nutrient solution supply may flow or stand or be supplied at intervals. Each track forms a tray-shaped accommodation unit.

Furthermore, and preferably, a distance between two adjacent tracks increases continuously in the radial direction from the inner part of the platform to the outer part of the platform. In this regard, the respective width of a track is preferably constant over its entire length. In the rhizosphere, the space thus remains constant in every region. The space around the container is constantly increased by it being continuously pushed outwards from the inner part of the platform to the outer part of the platform, so as it grows, the plant can spread out further. In this manner, loss of light in all regions because of the high leaf density can be minimized. Moving or thinning out and transplanting the individual plants is thus no longer vitally necessary. The plants can be placed in the tracks at the inner part of the platform. During growth, the plants are continuously pushed outwards along the tracks. This can be carried out in a simple manner by placing new plants at the inner part of the platform into the tracks and in this manner, the plants which have previously been placed in the tracks are pushed further outwards. This can be repeated with more plants by placing them in the individual tracks. When a plant reaches the outermost region or the outer part of the platform, they can be removed or harvested from the outside. Spacers may be provided or positioned between the individual containers inside a track.

Preferably, a combination of polygonal and round platforms may also be provided. As an example, the seed may be caused to germinate in containers on polygonal platforms. Next, the plants can be propagated and disposed on a round platform. In this regard, after germination, the plants can be placed in smaller containers and these can be placed in tracks on the round platform.

### BRIEF DESCRIPTION OF THE DRAWINGS

The invention will now be described in more detail with the aid of preferred embodiments, given by way of example.

The drawings schematically show:

FIG. 1: a climatically sealed climate cell with a plurality of tiers disposed one above the other,

FIG. 2: a tray-shaped accommodation unit with a plurality of containers disposed therein,

FIG. 3: a container for accommodating the plants and/or the seed,

FIG. 4: a two-part construction of the container from FIG. 3,

FIG. 4a: the principle of the disposition and fixing of the substrate inside the container,

FIG. 5: a plurality of annular platforms disposed one above the other,

FIG. 6: a platform in the form of a ring,

FIG. 6a: platforms in the shape of a section of a circle,

FIG. 7: a track of an annular platform, and

FIG. 7a: a container for placing in a track as shown in FIG. 7.

### PREFERRED EMBODIMENTS OF THE INVENTION

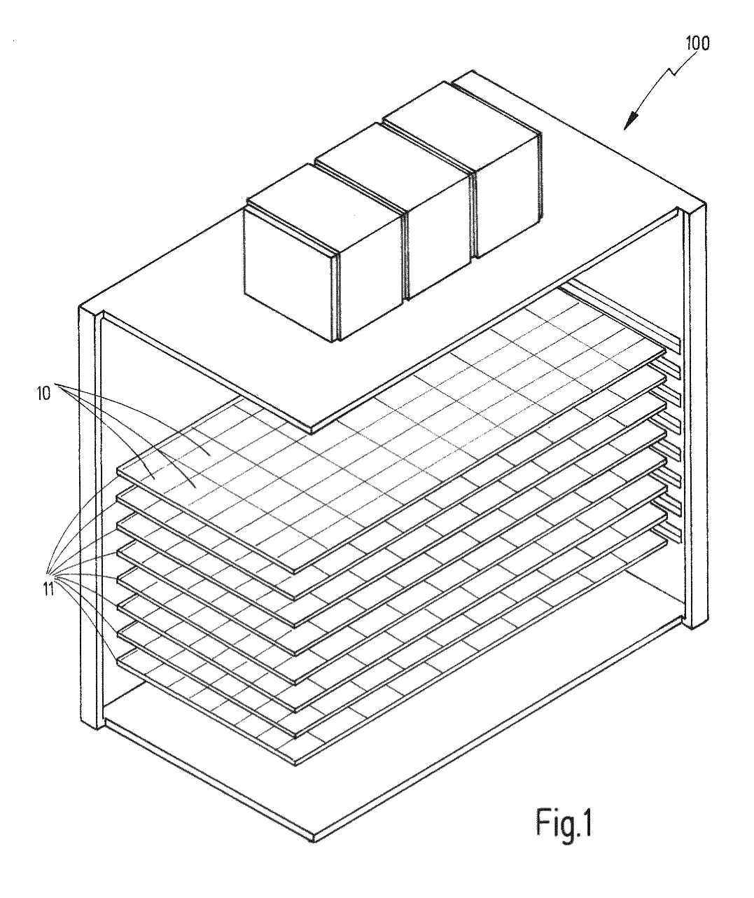

FIG. 1 shows a climatically sealed climate cell 100 for cultivating plants in indoor spaces. A plurality of tiers 11 are disposed inside the climatically sealed climate cell 100. In turn, a plurality of containers 10 are provided on each tier 11. Each container 10 forms an accommodation area 12 with a sheet-like substrate 13 (not shown in FIG. 1) for accommodating plants and/or seed.

For the purposes of clarity, the climatically sealed climate cell 100 in FIG. 1 is shown with half of it open.

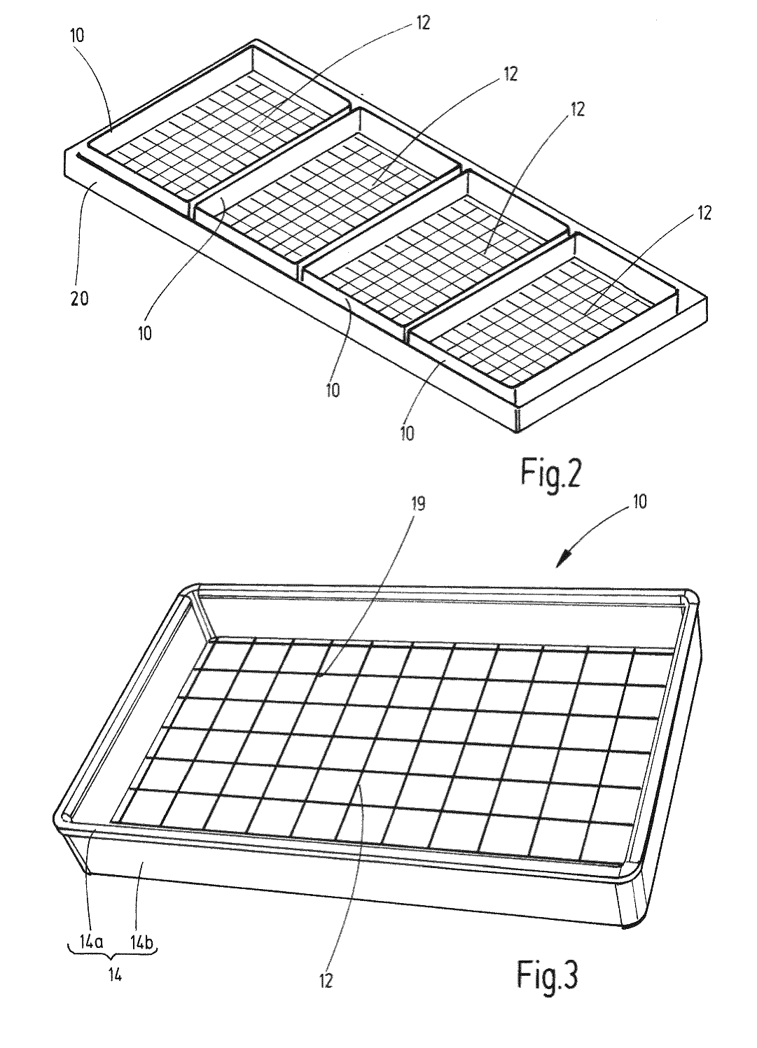

The individual containers 10 may be disposed in a tray-shaped accommodation unit 20. This is shown by way of example in FIG. 2. Water or a liquid nutrient solution may be disposed in the tray-shaped accommodation unit 20. The individual containers 10 may float on the liquid nutrient solution. The individual containers 10 have a peripheral frame 14 which respectively surrounds an accommodation area 12 for accommodating the plants and/or the seed. The tray-shaped accommodation area 20 shown in FIG. 2 is configured as a transportation unit, for example.

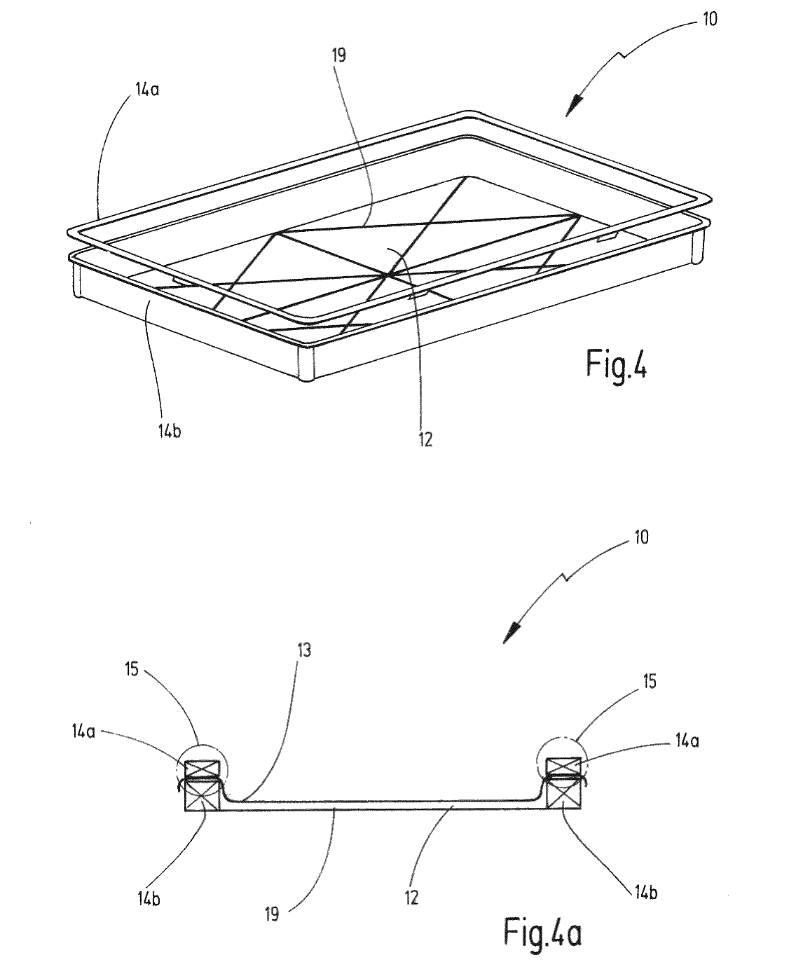

FIG. 3 shows a container 10 from FIG. 2. The frame 14 is two-part in configuration and consists of an upper, narrow first frame part 14a and a lower, taller second frame part 14b. The two frame parts 14a, 14b are plugged one on top of the other. The frame 14 surrounds the accommodation area 12. The accommodation area 12 is formed by a lattice-like base 19. A substrate 13 is disposed in a sheet-like manner in the accommodation area 12. For the purposes of clarity, the substrate 13 is not shown in FIG. 3. FIG. 4a shows a diagram of the principle for the disposition and fixing of the substrate 13.

FIG. 4 shows the two-part embodiment of the frame 14 for the container 10 of FIG. 3. The two frame parts 14a, 14b can be plugged one on top of the other by means of a tongue-and-groove connection. The substrate 13 can be clamped between the two frame parts 14a, 14b. In this manner, the substrate 13 is fixed in the region of the frame 14 and is disposed elevated compared with the central accommodation area 12, so that water or the nutrient solution cannot overflow over the edge onto the upper surface of the substrate 13.

FIG. 4a shows a representation of the principle of fixing the substrate 13 at the frame 14. The substrate 13 is clamped between the two frame parts 14a, 14b and is disposed or fixed at a position which is elevated compared with the accommodation area 12. If the container 10 is placed in a tray-shaped accommodation unit 20 onto a nutrient solution 18, then the nutrient solution stays solely underneath the substrate 13. The substrate 13 therefore floats on the nutrient solution 18. The seed or the plants can be disposed and fixed on the side of the substrate 13 facing away from the nutrient solution 18.

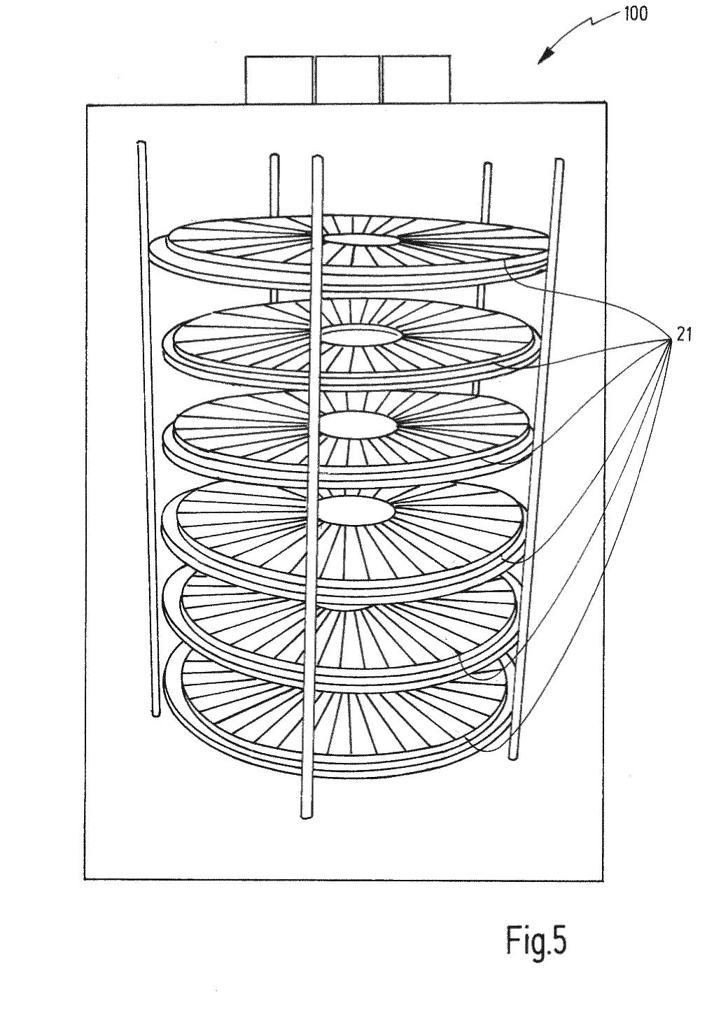

FIG. 5 shows an embodiment of a climatically sealed climate cell 100, wherein the individual tiers 11 are formed by platforms 21 which are essentially circular and annular in configuration.

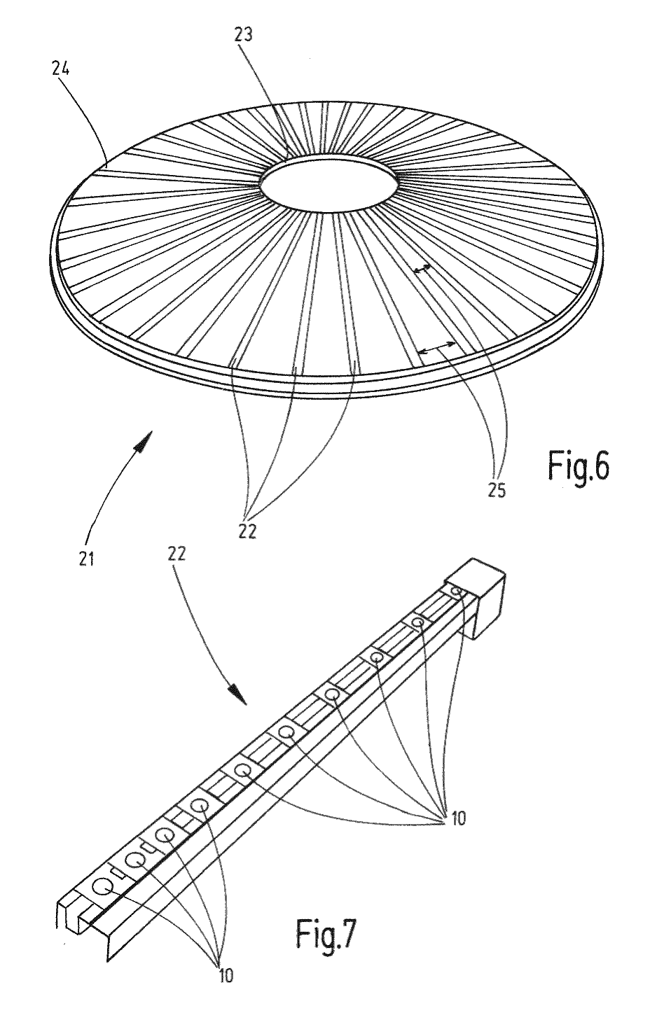

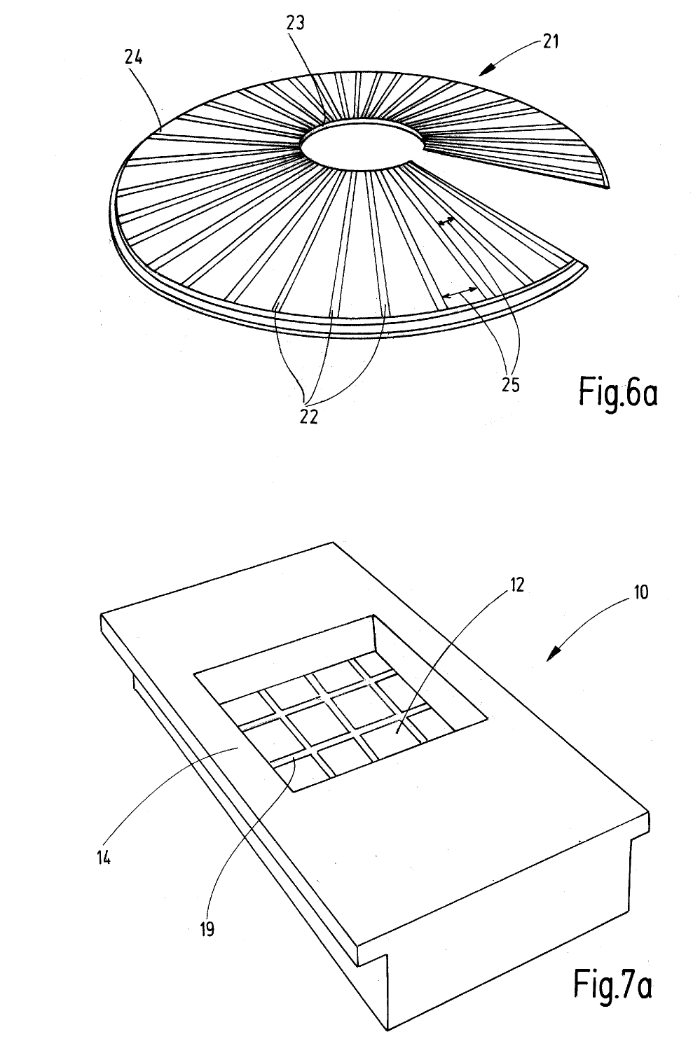

FIG. 6 shows an individual platform 21 from FIG. 5. In the central region, the platform 21 which is circular in configuration comprises a recess or a free region. Plants can be placed in a container 10 from this middle or central region into a track 22 in the region of the inner part of the platform 23. The tracks 22 run radially outwardly, whereupon the separation 25 between two adjacent tracks 22 increases continuously from the inner part to the outer part. New plants can be placed afresh in other containers 10 in the region of the inner part of the platform 23 and pushed away, whereupon the plants which have already been placed in their containers 10 are continuously pushed outwards, i.e. in the direction of the outer part of the platform 24. In this system which is shown by way of example, the tray-shaped accommodation unit 20 is configured as a track 22.

The width of the individual tracks 22 is constant along their length. The plants therefore do not have to be repotted or moved as they grow. They are simply displaced continuously from the inner part towards the outer part in the radial direction along a track 22. Because the separation 25 between two adjacent tracks 22 continuously increases from the inner part towards the outer part, the space for development of each individual plant at the outer part is greater than at the inner part. The fully grown plants can be removed and/or harvested at the outside or in the region of the outer part of the platform 24.

FIG. 6a shows platforms 21 which are configured in the shape of a section of a circle. In this manner, a gangway or path to the middle central section is formed, which makes access for personnel and/or machines easier.

FIG. 7 shows an individual track 22 with containers 10 placed therein. For the purposes of clarity, the plants in the containers 10 are not shown. Spacers can be placed between the individual containers 10 (for the purposes of clarity, this is not shown in FIG. 7).

FIG. 7a shows a further embodiment of a container 10. For the purposes of clarity, the container 10 in FIG. 7a is shown without the substrate 13. The container 10 shown in FIG. 7a is particularly configured for use in a track 22 from FIG. 7.

### LIST OF REFERENCE NUMERALS

100 climatically sealed climate cell
10 container
11 tiers
12 accommodation area
13 substrate
14 frame
14a, 14b frame parts
15 fixing means
16 first side of substrate
17 second side of substrate
18 nutrient solution
19 base of container
20 basin-shaped accommodation unit
21 platform
22 track
23 inner part of the platform
24 outer part of the platform
25 distance between two adjacent tracks

1.-15. (canceled)

16. A climatically sealed climate cell for cultivating plants in indoor spaces, wherein a plurality of containers are disposed one above the other in at least two tiers inside the climate chamber, wherein each container comprises an accommodation area with a substrate disposed in the manner of a sheet to accommodate the plants and/or to accommodate seeds, wherein the container comprises a frame which surrounds the perimeter of the accommodation area, and the frame comprises at least one fixing means for temporarily or permanently fastening the substrate to the frame.

17. The climatically sealed climate cell as claimed in claim 16, wherein the climate cell comprises regulating means to regulate a temperature and/or a relative humidity and/or a carbon dioxide content and/or an oxygen content and/or an air speed inside the climate cell.

18. The climatically sealed climate cell as claimed in claim 16, wherein the substrate is configured as a film and/or mat and/or membrane, in particular as a hydromembrane.

19. The climatically sealed climate cell as claimed in claim 18, wherein the membrane is permeable to particles, in particular particles of water and/or nutrient particles, up to a maximum particle size of 5 nm, preferably 2.5 nm, and more particularly preferably 1.5 nm.

20. The climatically sealed climate cell as claimed in claim 16, wherein a first side of the substrate lies on a liquid nutrient solution, and wherein the plant and/or the seed lies on a second side of the substrate facing away from the liquid nutrient solution.

21. The climatically sealed climate cell as claimed in claim 20, wherein no liquid nutrient solution and no water is disposed on the second side.

22. The climatically sealed climate cell as claimed in claim 16, wherein the substrate is fixed to the frame elevated compared with the accommodation area, by means of the fixing means.

23. The climatically sealed climate cell as claimed in claim 16, wherein the at least one fixing means partially or completely surrounds the container and/or in that the at least one fixing means is disposed along the frame.

24. The climatically sealed climate cell as claimed in claim 16, wherein the frame is formed in multiple parts, wherein the fixing means is formed by at least one frame part.

25. The climatically sealed climate cell as claimed in claim 24, wherein a first frame part forms a groove and a second frame part forms a tongue, whereupon both frame parts can be connected by means of a tongue-and-groove connection, whereupon the substrate is clamped and fixed between the two frame parts.

26. The climatically sealed climate cell as claimed in claim 16, wherein the container comprises a base with apertures or a lattice-like base, wherein the substrate lies on the base.

27. The climatically sealed climate cell as claimed in claim 16, wherein the container is disposed in a tray-shaped accommodation unit.

28. The climatically sealed climate cell as claimed in claim 16, wherein the at least two tiers are formed by essentially annular or circular or part-circular or polygonal platforms disposed one above the other, wherein a plurality of containers are respectively disposed on a platform.

29. The climatically sealed climate cell as claimed in claim 28, wherein each platform comprises a plurality of mutually separated and radially orientated tracks in which the containers are disposed and which can be displaced from an inner part of the platform in the direction of an outer part of the platform.

30. The climatically sealed climate cell as claimed in claim 29, wherein a distance between two adjacent tracks increases continuously in the radial direction from the inner part of the platform to the outer part of the platform.
